(19) United States
(12) Patent Application Publication
(10) Pub. No.: US 2025/0155566 A1
(43) Pub. Date: May 15, 2025

(54) Method and Apparatus for Detecting Falling Objects via a Wireless Communication Network

(71) Applicant: Telefonaktiebolaget LM Ericsson (publ), Stockholm (SE)

(72) Inventors: Magnus Thurfjell, Luleå (SE); Peter Ökvist, Luleå (SE)

(21) Appl. No.: 18/839,168

(22) PCT Filed: Apr. 22, 2022
(86) PCT No.: PCT/SE2022/050391

§ 371 Date: Aug. 16, 2024

(51) Int. Cl. G01S 13/52; G01S 7/00; G01S 7/41

(52) U.S. Cl. CPC G01S 13/52; G01S 7/006; G01S 7/415

(57) ABSTRACT

A wireless communication network (30) provides communication services and detects falling objects by evaluating channel estimates derived from reference signals transmitted between nodes the network (30). For example, one or more User Equipments (UEs) (12) transmit uplink reference signals (14) at recurring times, e.g., many times per second. An access node (16) or other processing node (34) of the network (30) evaluates the received reference signals (14) to discern changing propagation paths that are characteristic of a reflective object falling within the space intervening between the UE(s) (12) and the access node (16).

### TECHNICAL FIELD

An access node of a wireless communication system and a corresponding method of operation provide for detection of falling objects based on evaluating uplink channel estimates.

### BACKGROUND

Falling objects are an obvious hazard associated with rock faces in cliffsides, tunnels, open pits, dam faces, or essentially any type of excavation or construction works. In the context of excavations or construction works, failures can to some extent be mitigated by different types of reinforcements, such as shotcrete, precast concrete linings, rock bolts, or metal beams. However, reinforcements may be practical only in limited areas or not at all and such reinforcements do not eliminate the risk of rock falls.

Consequently, there is wide interest in predicting and detecting falling objects such as rock or concrete. For example, ground penetrating radar (GPR) systems provide a mechanism for detecting rocks that have fallen from a tunnel roof onto the inner lining of the tunnel. Another approach embeds sound or other seismic sensors in the rock face or structure of interest to monitor stability and detect areas of increasing stress. While such seismic monitoring offers valuable monitoring data, costs become prohibitive when deployment involves dense deployment over large areas and use may be limited to critical areas.

Other systems rely on LIDAR-light detection and ranging-to detect fallen rocks or other obstructions that have fallen into a monitored zone or space. Such systems have particular value in the context of transitways, such as roads, railways, etc., where obstructions pose hazards for vehicles moving along the transitways. Yet other systems rely on RADAR—radio detection and ranging—for falling object detection. RADAR systems provide the ability to detect falling objects in real time and may even provide the ability to register trajectories of such objects. Still other systems use cameras or other vision-based sensors for falling or fallen object detection.

Systems involving dedicated monitoring infrastructure tend to be expensive and the expense often limits their deployment only to critical areas, such as active areas of a mine or tunneling project. A further disadvantage is linking the monitoring points or subsystems together and gaining communicative access to their data, e.g., for reporting to a remote monitoring center.

### SUMMARY

A wireless communication network provides communication services and detects falling objects by evaluating channel estimates derived from reference signals transmitted between nodes the network. For example, one or more User Equipments (UEs) transmit uplink reference signals at recurring times, e.g., many times per second. An access node or other processing node of the network evaluates the received reference signals to discern changing propagation paths that are characteristic of a reflective object falling within the space intervening between the UE(s) and the access node.

One embodiment comprises a method of operation by a processing node of a wireless communication system, wherein the processing node is integrated or associated with an access node of the wireless communication network. The method includes the processing node obtaining a series of uplink channel estimates with respect to each of one or more user equipments (UEs). Each series is determined from the access node receiving successive transmissions of an uplink reference signal by a corresponding one of the one or more UEs, and each uplink channel estimate is dependent upon prevailing uplink propagation paths between the corresponding UE and the access node. The method further includes evaluating the series of uplink channel estimates to determine whether changes in the prevailing uplink propagation paths in the series are indicative of a falling object, and outputting trigger signaling in response to determining that the changes are indicative of a falling object.

Another example embodiment comprises a system that includes one or more UEs positioned in an area to be monitored for falling objects, each UE comprising a sensor device that communicates sensor data via uplink data transmissions. The system further includes an access node comprising or associated with reception equipment configured to receive the uplink data transmissions from each of the one or more UEs, along with uplink reference signals transmitted from each of the one or more UEs. Still further, the system includes a processing node that is integrated or associated with the access node. The processing node is configured to obtain a series of uplink channel estimates with respect to each of the one or more UEs, where each series is determined from the access node receiving successive transmissions of an uplink reference signal by a corresponding one of the one or more UEs. Each uplink channel estimate is dependent upon prevailing uplink propagation paths between the corresponding UE and the access node, and the processing node is further configured to evaluate the series of uplink channel estimates with respect to the one or more UEs, to determine whether changes in the prevailing uplink propagation paths in the series are indicative of a falling object, and output trigger signaling in response to determining that the changes are indicative of a falling object.

Yet another example embodiment comprises a processing node that is integrated or associated with an access node of a wireless communication system. The processing node includes communication interface circuitry and processing circuitry. The processing circuitry is configured to obtain a series of uplink channel estimates with respect to each of one or more UEs, where each series is determined from the access node receiving successive transmissions of an uplink reference signal by a corresponding one of the one or more UEs. In this context, each uplink channel estimate is dependent upon prevailing uplink propagation paths between the corresponding UE and the access node. The processing circuitry of the processing node is further configured to evaluate the series of uplink channel estimates to determine whether changes in the prevailing uplink propagation paths in the series are indicative of a falling object, and output, via the communication interface circuitry, trigger signaling in response to determining that the changes are indicative of a falling object.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an access node and an integrated or associated processing node according to one embodiment, shown in context with example uplink propagation paths between a wireless communication device and the access node.

FIG. 2 is an example power delay profile corresponding to the multipath uplink channel suggested by FIG. 1.

FIG. 3 is an example phase plot corresponding to the multipath uplink channel suggested by FIG. 1.

FIG. 4 is a block diagram of a wireless communication network, according to one embodiment.

FIG. 5 depicts block diagrams of a wireless communication device, an access node, and a processing node, according to one or more embodiments.

FIG. 6 is a logic flow diagram of a method of operation by a system, according to one embodiment.

FIG. 7 is a logic flow diagram of a method of operation by a processing node, according to one embodiment.

FIG. 8 is a block diagram of an access node according to another example embodiment.

FIGS. 9 and 10 are block diagrams of a processing node according to further example embodiments.

FIGS. 11A and 11B depict a logic flow diagram of a method of operation by a system according to another embodiment.

FIG. 12 is a block diagram of an example access node and a processing node integrated or associated with the access node, in an example deployment in a tunnel environment.

### DETAILED DESCRIPTION

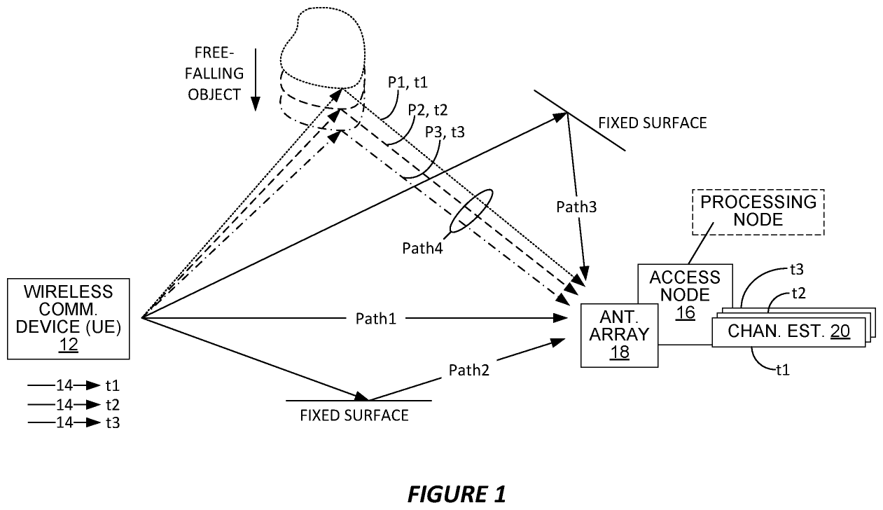

FIG. 1 illustrates a wireless communication device 12, also referred to as a User Equipment (UE) 12, with the UE 12 transmitting an uplink reference signal 14 at successive times t1, t2, and t3. For example, the UE 12 transmits the uplink reference signal 14 many times per second.

The diagram illustrates a multipath channel between the UE 12 and an access node 16 of a wireless communication network. The access node 16 includes or is associated with an antenna array 18 that is used to receive uplink transmissions from the UE 12, where those transmissions are received over the multipath channel. Here, the UE 12 and the access node 16 may be located within a mine, tunnel, pit, along a cliff face, or in another area where falling objects might be expected.

As a non-limiting example, the multipath channel includes four propagation paths, Path1, Path2, Path3, and Path4, between the UE 12 and the access node 16 or, more particularly, between the UE 12 and the antenna array 18. There may be more paths or fewer paths and FIG. 1 merely offers an example. Further, it will be appreciated that paths associated with received signal strengths below a certain threshold at the access node 16 may be ignored.

Path 4 is a reflected path, with the reflections from a free falling rock or other object being received at the access node 16. As such, Path 4 changes as the free falling object descends. FIG. 1 suggests these changes by illustrating a free falling object at successive positions corresponding to the respective times at which the UE 12 transmits the uplink reference signal, e.g., position P1 at time t1, and successively lower positions P2 and P3 at respective times t2 and t3. Consequently, the Path4 component in the channel estimates 20 generated at the access node 16 responsive to reception of the uplink reference signal 14 at the respective times t1, t2, and t3 will reflect the successively changed position of the free falling object.

In general, falling objects that are intervening between the UE 12 and the antenna array 18 affect the multipath channel, at least if certain conditions are met, such as a minimum object size, with these affects manifested in the channel estimates determined during time instances in which the falling object intervenes within the multipath channel. According to one or more embodiments, a processing node is configured to evaluate the channel estimates 20 to detect falling objects and output trigger signaling in response to detecting a falling object. Trigger signaling comprises alert signaling, for example. Additionally or alternatively, the trigger signaling comprises notification signaling, control signaling, or other signaling that initiates one or more other nodes or systems to take action responsive to the falling-object detection.

The processing node may be the access node 16, e.g., it may be integrated with the access node 16, or it may be associated with the access node 16. For example, the processing node is a cloud-based node that is communicatively linked with the access node 16, possibly through one or more intermediate nodes. As such, any references herein to a processing node may be understood as an interchangeable reference to an access node 16 that is configured to perform the described processing operations, or to another node that is associated with the access node 16, at least to the extent that it has access to channel estimates 20 determined from reception of the uplink reference signals 14 from one or more UEs 12 at an antenna array 18 associated with the access node 16.

In one or more embodiments, the access node 16 is part of a Fifth Generation (5G) New Radio (NR) network or other wireless communication network that uses high-frequency communication signals suitable for the falling-object detection operations disclosed herein. Correspondingly, one or more embodiments have the advantage of “piggybacking” falling-object detection onto normal, ongoing communications operations, which may involve the recurring transmission of uplink reference signals by the UE 12. Alternatively, operations associated with falling-object detection are multiplexed or interleaved with communications operations. For example, there may be additional uplink reference signal transmissions or additional channel-estimation processing beyond that needed for communications, for detection of falling objects.

In either case, there may be multiple UEs 12 within the environment and the processing node may use channel estimates 20 generated with respect to multiple UEs 12 for falling-object detection. A “UE” in this sense shall be understood as essentially any item of equipment that includes or is associated with a communication module that is operative to connect to the access node 16 according to the requirements of the air interface provided by the access node 16. In one or more embodiments, there are multiple UEs 12 that are sensor devices, e.g., for sensing vibration or sound, with such sensor devices embedded in or arrayed on a rock face or other exposed surface along which falling object detection is desired.

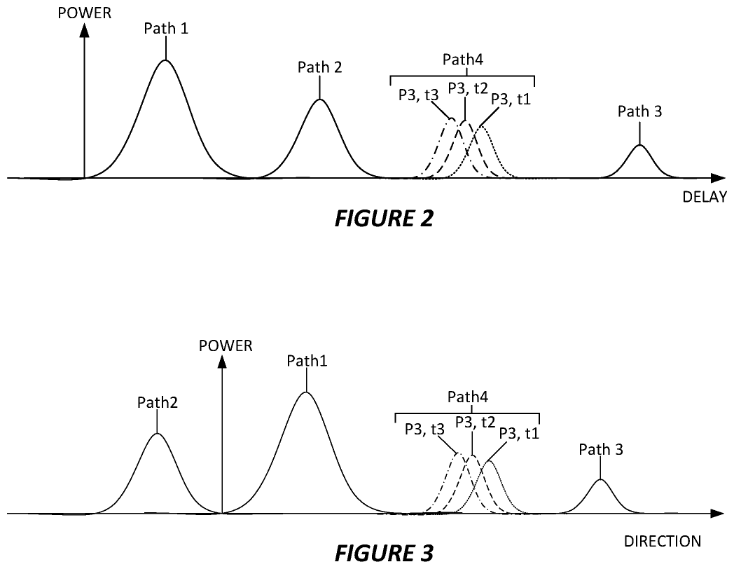

FIGS. 2 and 3 illustrate a power delay profile and phase plot, respectively, for the multipath channel introduced in FIG. 1. These plots are not to scale and are provided only as simplified examples for discussion. A primary point of interest in both FIGS. 2 and 3 is the changing behavior of Path 4 over the successive times t1, t2, and t3, corresponding to the free falling object moving from position P1 to position P2 and then from position P2 to position P3. Because the times t1, t2, and t3 are known, the way the Path4 changes can be evaluated for consistency with the acceleration and track that would apply for a free falling object, and the processing node is configured to perform such assessment, for detection of free falling objects within the propagation paths between respective UEs 12 and the antenna array(s) 18 used to receive the uplink reference signals 14 transmitted over such paths.

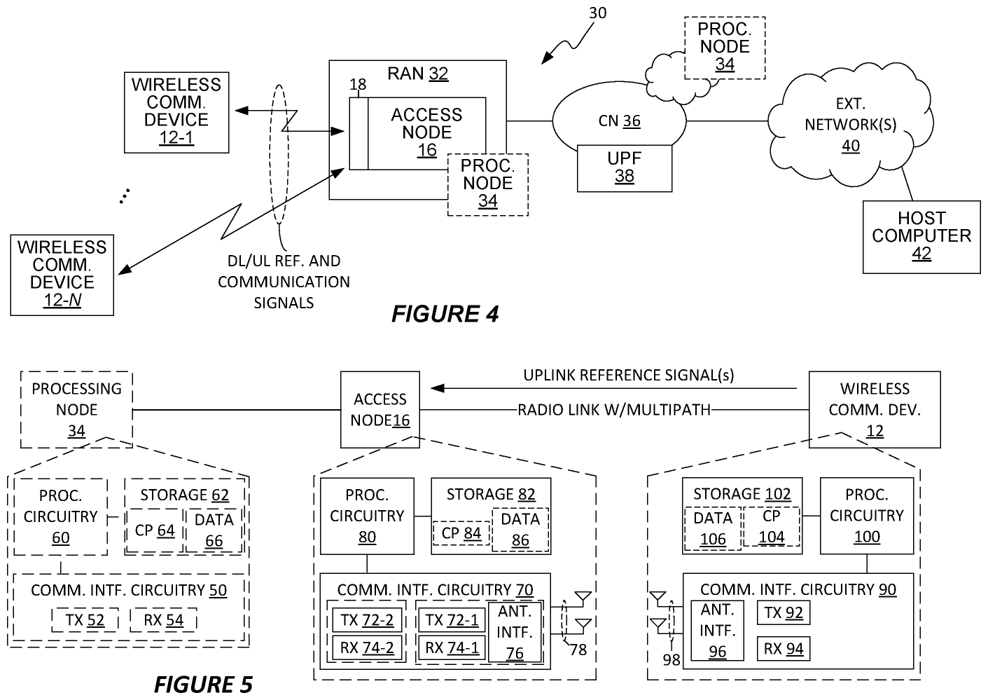

FIG. 4 illustrates a wireless communication network 30 according to an example embodiment, which includes a Radio Access Network (RAN) 32 comprising an access node 16 with an antenna array 18 for transmitting downlink (DL) reference and communication signals for respective UEs 12, e.g., 12-1 through 12-N, where the UEs 12 may be sensor devices or other types of monitoring devices configured for monitoring the stability of a rock face or construction works. Of course, there may be other types of UEs 12 served by the access node(s) 16 and the wireless communication network 30 at large, e.g., the wireless communication network 30 comprises, for example, a 5G NR network that provides a multiplicity of communication services, such as mobile broadband (MBB), ultra-low latency communications (ULCC), and narrowband internet of things (NB-IoT).

In an example embodiment, the processing node 34 that evaluates the channel estimates 20 for falling-object detection may be integrated or associated with the access node 16, and FIG. 1 depicts this arrangement by showing the processing node 34 in dashed lines, in an integrated or co-located configuration with respect to the access node 16. The RAN 32 may, of course, contain multiple access nodes 16, and each access node 16 may be configured to operate as a processing node 34 for evaluating channel estimates 20 for the respective access node 16, for falling-object detection.

Alternatively, a centralized processing node 34 may be implemented elsewhere in the wireless communication network 30. FIG. 1 illustrates one example of such embodiments, wherein a centralized, cloud-based processing node 34 is accessible via the Core Network (CN) 36 of the wireless communication network 30. Especially in embodiments where the processing node 34 is cloud-based, the processing node 34 may be virtualized and there may be multiple instantiations of the processing node 34, to support free-falling object detection with respect to different access nodes 16 or clusters of access nodes 16.

The CN 36 is shown in simplified form and may include multiple nodes providing network functions in support of communication services and corresponding control, such as one or more user plane functions (UPF) 38, providing connectivity to external networks 40, such as the Internet, which in turn provides access to a multiplicity of services. As one example, one or more of the UEs 12 report sensor data to a host computer 42 that is accessible through the external network(s) 40, using the wireless communication network 30 as an access network.

The above example demonstrates that references to a processing node 34 that is integrated or associated with an access node 16 means that the processing node 34 may be implemented within the access node 16—i.e., the native functionality of the access node 16 is extended to include the processing operations associated with the processing node 34 described herein—or means that the processing node 34 is communicatively coupled with the access node 16, such that it obtains channel estimates 20 from the access node 16 or obtains the underlying data from the access node 16 on which the channel estimates 20 are based. In embodiments where the processing node 34 is communicatively coupled with the access node 16, the coupling may be direct, such as where individual processing nodes 34 are co-located with respective access nodes 16 in the RAN 32, or the coupling may be indirect, such as suggested in FIG. 1, with the processing node(s) 34 located in or accessible through the CN 36.

Thus, although FIG. 5 illustrates an example processing node 34 separate from an associated access node 16, it shall be understood that the access node 16 itself may incorporate the functionality of the processing node 34. With that in mind, an example processing node 34 comprises communication interface circuitry 50, including transmitter circuitry 52 and receiver circuitry 54. Such circuitry includes physical layer circuitry for transmitting and receiving signaling over the involved transmission medium-wired or wireless-along with timing and protocol-handling circuitry. As a non-limiting example, the communication interface circuitry 50 comprises an Ethernet or other computer-network interface. Broadly, the communication interface circuitry 50 is configured to receive signaling associated with uplink reference signals 14 received by one or more access nodes 16, e.g., channel estimates 20 computed by the access node 16 from reception of uplink reference signals 14 from respective UEs 12 at respective transmission times. Further, the communication interface circuitry 50 is configured to output trigger signaling, such as electronic messages or other signaling that initiates one or more actions to be taken in response to detection of a falling object.

The processing node 34 further includes processing circuitry 60 that comprises dedicated, fixed circuitry, or programmatically-configured circuitry, or a mix of fixed circuitry and programmatically-configured circuitry. In at least one embodiment, the configuration of the processing circuitry 60 is realized via the execution of computer program instructions from a computer program (CP) 64 held in storage 62. The storage 62 may also hold one or more types of data 66, such as various configuration parameters to control falling-object detection. Example parameters include one or more thresholds or other qualifiers, used to eliminate, or at least reduce false detection events, or used to control whether falling-object detection is active. This latter parameter applies primarily in the case where the processing node 34 is implemented within the access node 16—e.g., there may be access nodes 16 that cover spaces in which falling object detection is applicable and other access nodes 16 that cover spaces where falling object detection is not applicable.

The storage 62 comprises one or more types of computer readable media, such as volatile working memory for program execution and associated data, and non-volatile memory for longer term storage of program data, configuration data, etc. Example memory or device types comprised in the storage 62 include any one or more of DRAM, SRAM, ROM, EEPROM, FLASH, Solid State Disk (SSD), or optical or electromagnetic storage.

An example access node 16 comprises communication interface circuitry 70, including radiofrequency transmitter circuitry 72-1, radiofrequency receiver circuitry 74-1, and antenna interface circuitry 76 configured to couple to an antenna array, shown here as a plurality of antennas or antenna elements 78. These elements of the communication interface circuitry 70 provide an air interface for transmitting signals to and receiving signals from UEs 12. Additionally, the communication interface circuitry 70 of the access node 16 includes circuitry for communicatively coupling to other nodes in the wireless communication network 30, e.g., other access nodes 16 and one or more types of CN nodes, such as the aforementioned UPF 38. Such circuitry is shown as transmitter circuitry 72-2 and receiver circuitry 74-2. Such circuitry is configured to support one or more types of sidehaul and backhaul connectivity, as used in the wireless communication network 30 to interlink access nodes 16 and to couple access nodes 16 with the CN 36.

The access node 16 further includes processing circuitry 80 that comprises dedicated, fixed circuitry, or programmatically-configured circuitry, or a mix of fixed circuitry and programmatically-configured circuitry. In at least one embodiment, the configuration of the processing circuitry 80 is realized via the execution of computer program instructions from a computer program (CP) 84 held in storage 82. The storage 82 may also hold one or more types of data 86, such as various configuration parameters.

The storage 82 comprises one or more types of computer readable media, such as volatile working memory for program execution and associated data, and non-volatile memory for longer term storage of program data, configuration data, etc. Example memory or device types comprised in the storage 82 include any one or more of DRAM, SRAM, ROM, EEPROM,

FLASH, Solid State Disk (SSD), or optical or electromagnetic storage.

An example UE 12 comprises communication interface circuitry 90, including radiofrequency transmitter circuitry 92, radiofrequency receiver circuitry 94, and antenna interface circuitry 96 configured to couple to an antenna array, shown here as a plurality of antennas or antenna elements 98. These elements of the communication interface circuitry 90 are configured to connect to access nodes 16 of the wireless communication network 30, according to the applicable air interface(s)/Radio Access Technologies (RATs). The communication interface circuitry 90 of the UE 12 may also include additional wireless or wired communication circuitry, such as for near field communications (NFC), Bluetooth, etc.

The UE 12 further includes processing circuitry 100 that comprises dedicated, fixed circuitry, or programmatically-configured circuitry, or a mix of fixed circuitry and programmatically-configured circuitry. In at least one embodiment, the configuration of the processing circuitry 100 is realized via the execution of computer program instructions from a computer program (CP) 104 held in storage 102. The storage 102 may also hold one or more types of data 106, such as various configuration parameters.

The storage 102 comprises one or more types of computer readable media, such as volatile working memory for program execution and associated data, and non-volatile memory for longer term storage of program data, configuration data, etc. Example memory or device types comprised in the storage 102 include any one or more of DRAM, SRAM, ROM, EEPROM, FLASH, Solid State Disk (SSD), etc.

With reference to the example of FIG. 5, a processing node 34 as disclosed herein is configured to obtain and evaluate channel estimates 20 derived from the reception of uplink reference signals 14 transmitted by one or more UEs 12 and received at one or more antenna arrays 18, which correspond to one or more access nodes 16 of a wireless communication network 30. The example processing node 34 is integrated or associated with an access node 16 and it includes communication interface circuitry 50 and processing circuitry 60.

The processing circuitry 60 is configured to obtain a series of uplink channel estimates 20 with respect to each of one or more user equipments UEs 12, each series determined from the access node 16 receiving successive transmissions of an uplink reference signal 14 by a corresponding one of the one or more UEs 12, and each uplink channel estimate 20 dependent upon prevailing uplink propagation paths between the corresponding UE 12 and the access node 16—i.e., between the corresponding UE 12 and the antenna array 18 of the access node 16 that is used to receive the uplink reference signals 14. The processing circuitry 60 is further configured to evaluate the series of uplink channel estimates 20 to determine whether changes in the prevailing uplink propagation paths in the series are indicative of a falling object, and output, via the communication interface circuitry 50, trigger signaling in response to determining that the changes are indicative of a falling object. In general, the processing circuitry 60 is operatively associated with the communication interface circuitry 50 in that it is operative to send messages or other signaling via the communication interface circuitry 50 and to receive messages or other signaling via the communication interface circuitry 50.

In an example operational scenario, there are two or more UEs 12. Correspondingly, the processing circuitry 60 is configured to evaluate the series of uplink channel estimates 20 to determine whether changes in the prevailing uplink propagation paths in the series are indicative of a falling object by independently evaluating the series from each UE 12 and outputting the trigger signaling responsive to the changes in any one or more of the series being indicative of a falling object. Alternatively, the processing circuitry 60 is configured to jointly evaluate the series from at least two of the two or more UEs 12 and output the trigger signaling responsive to the changes in the jointly-evaluated series being indicative of a falling object.

Each channel estimate 20 comprises path delay and direction estimates, such that the changes in each series of channel estimates 20 comprise changes in the path delays and direction estimates over successive ones of the channel estimates 20 comprised in the series. For reference, see the Path4 example of FIG. 1, which involves reflections from a falling object and exhibits characteristic changes over success times t1, t2, and t2, corresponding to successive receptions at an access node 16 of an uplink reference signal 14 from a UE 12.

In at least one embodiment, the processing circuitry 60 is configured to evaluate a series of uplink channel estimates 20 to determine whether changes in the prevailing uplink propagation paths in the series are indicative of a falling object by determining whether any one or more of the series exhibit path changes characteristic of objects free falling under the force of gravity. For example, a free falling object exhibits a time-squared acceleration vector and evaluation of the path changes may be based on computing an acceleration vector from the changing channel estimates and using corresponding direction-of-arrival computations, to determine whether observed path changes are characteristic of reflections from a free falling object.

In at least one embodiment, the one or more UEs 12 transmitting the uplink reference signals 14 of interest are respective sensor devices, such as sound, vibration, or other type of seismic sensors. The processing node 34 in question is an access node 16 serving the one or more UEs 12, and the processing circuitry 60 is configured to receive sensor data from each of the one or more UEs 12, via respective uplink data transmissions, for sending towards an external host computer 42. Further, the processing circuitry 60 is configured to use the series of uplink channel estimates 20 corresponding to each UE 12, or further channel estimates based on the underlying reference-signal reception data from which the series of uplink channel estimates 20 are derived, for receiving the uplink data from the UE 12.

In one or more embodiments, each UE 12 among one or more UEs 12 served by an access node 16 has a known location relative to reception equipment included in or used by the access node 16 for reception of the uplink reference signal transmissions. Here, the reception equipment includes, at least, an antenna array 18. Correspondingly, the processing circuitry 60 of a processing node 34 that is integrated or associated with the access node 16 is configured to evaluate the series of uplink channel estimates 20 to determine whether changes in the prevailing uplink propagation paths in the series are indicative of a falling object, based on using the known locations of the UEs 12 to identify propagation-path changes that correlate with an object free falling under the force of gravity. That is, the known locations of the UE(s) 12 provide a basis for determining movement of a reflecting object across success transmissions of uplink reference signals 14 by the UE(s) 12.

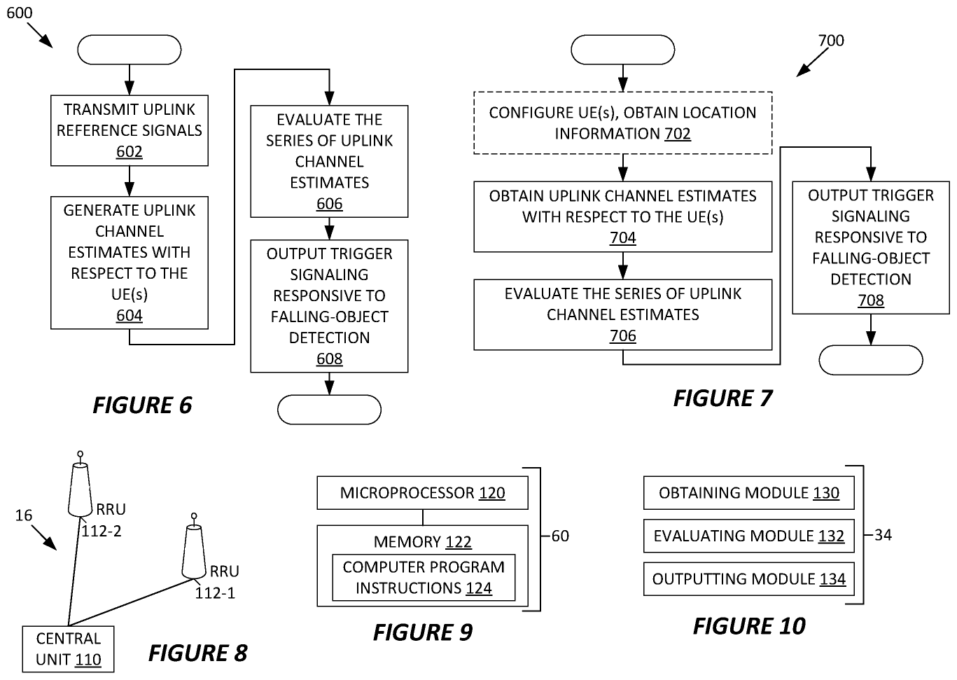

FIG. 6 illustrates a method 600 of operation by a “system” that includes one or more UEs 12 and an access node 16 that is operative as a processing node 34, or an access node 16 that is associated with a processing node 34. The method 600 includes the one or more UEs 12 transmitting (Block 602) uplink reference signals 14, e.g., at successive times, and the access node 16 or the processing node 34 generating (Block 604) uplink channel estimates 20 with respect to the UE(s) 12. Processing continues with the processing node 34 evaluating (Block 606) the generated series of uplink channel estimates 20, and outputting (Block 608) trigger signaling responsive to falling object detection-i.e., responsive to path changes in the generated series of uplink channel estimates 20 being consistent with reflections of the uplink reference signals(s) 14 off of a free falling object within the intervening space between the UE(s) 12 and the antenna array(s) 18 used for receiving the uplink reference signals 14.

FIG. 7 illustrates a method 700 of operation by an access node 16 or by another node in a wireless communication network 30 that is configured to operate as a processing node 34. The method 700 includes the processing node 34 obtaining (Block 704) a series of uplink channel estimates 20 with respect to each of one or more user equipments UEs 12, each series determined from the access node 16 receiving successive transmissions of an uplink reference signal 14 by a corresponding one of the one or more UEs 12. Each uplink channel estimate 20 depends upon prevailing uplink propagation paths between the corresponding UE 12 and the access node 16. Obtaining the uplink channel estimates comprises, for example, the processing node 34 receiving them from the access node 16 directly or through one or more intermediate nodes, in embodiments where the access node 16 does not act as the processing node 34.

The method 700 further includes the processing node 34 evaluating (Block 706) the series of uplink channel estimates 20 to determine whether changes in the prevailing uplink propagation paths in the series are indicative of a falling object, and outputting (Block 708) trigger signaling in response to determining that the changes are indicative of a falling object. Further, as a preparatory or initialization step, the method 700 may include the processing node obtaining (Block 702) location information for the UE(s) 12 that are being used in the context of falling object detection. In cases where an access node 16 serving the UEs 12 acts as the processing node 34, the preparatory operations may include configuring the UEs 12. One example of such configuration operations includes configuring the UEs 12 to transmit uplink reference signals 14 more often or according to particular patterns or coded sequences, to facilitate falling object detection. Of course, it may be that the nominal, communications-related transmission of uplink reference signals 14 by the UEs 12 is sufficient to support falling object detection without need for special configurations.

With respect to two or more UEs 12, in one embodiment, evaluating (Block 706) the series of uplink channel estimates 20 to determine whether changes in the prevailing uplink propagation paths in the series are indicative of a falling object comprises independently evaluating the series from each UE 12 and correspondingly outputting (Block 708) the trigger signaling responsive to the changes in any one or more of the series being indicative of a falling object. Alternatively, determining whether changes in the prevailing uplink propagation paths in the series are indicative of a falling object comprises jointly evaluating the series from at least two of the two or more UEs 12 and outputting (Block 708) the trigger signaling responsive to the changes in the jointly-evaluated series being indicative of a falling object.

Determining whether changes in the prevailing uplink propagation paths in the series are indicative of a falling object comprises, for example, determining whether any one or more of the series exhibit path changes characteristic of objects free falling under the force of gravity.

As noted, a given access node 16 may act as the processing node 34 for evaluating uplink channel estimates 20 generated by the access node 16, and the method 700 in such embodiments may further comprise the access node 16 receiving sensor data from each of the one or more UEs 12, via respective uplink data transmissions, for sending towards an external host computer 42. Advantageously, then, the same node that provides air interface connectivity for the UEs 12 operating as sensor devices in a tunnel, mine, or other environment where falling object detection is used, also provides the processing for falling object detection. More generally, an advantage of the wireless communication system 30 at large is that it provides communication services and falling object detection, such as by providing a pathway for uplink channel estimates 20 determined from the reception of uplink reference signals 14 at one or more access nodes 16 to flow to a processing node 34, for evaluation of the uplink channel estimates 20, for falling object detection.

In an embodiment where an access node 16 also operates as a processing node 34 for evaluating uplink channel estimates 20 generated by the access node 16 with respect to one or more UEs 12 served by it, the access node 16 may advantageously use the series of uplink channel estimates 20 corresponding to each UE 12, or further channel estimates based on the underlying reference-signal reception data from which the series of uplink channel estimates 20 are derived, for receiving the uplink data from the UE(s) 12. That is, in one or more embodiments, the processing performed at the access node 16 for ongoing channel estimation in the context of receiving uplink data transmissions from one or more UEs 16 is put to the dual use of falling object detection, where the latter use looks at the changes in successive channel estimates 20 to discern whether any path changes are characteristic of one or more of the paths involving reflections from a free falling object.

In one or more embodiments, each UE 12 among the one or more UEs 12 served by a given access node 16 has a known location relative to reception equipment included in or used by the access node 16 for reception of the uplink reference signal transmissions. For example, the UEs 12 are embedded sensors installed at fixed, known locations within a mine, tunnel, cliff face, etc. Correspondingly, evaluating (Block 706) the series of uplink channel estimates 20 to determine whether changes in the prevailing uplink propagation paths in the series are indicative of a falling object is based on using the known locations of the UEs 12 to identify propagation-path changes that correlate with an object free falling under the force of gravity.

With FIGS. 6 and 7 in mind, an example system comprises one or more UEs 12 positioned in an area to be monitored for falling objects, where each UE 12 comprises a sensor device that communicates sensor data via uplink data transmissions, an access node 16 comprising or associated with reception equipment configured to receive the uplink data transmissions from each of the one or more UEs 12, along with uplink reference signals 14 transmitted from each of the one or more UEs 12, and a processing node 34 that is integrated or associated with the access node 16.

The processing node 34 is configured to: (a) obtain a series of uplink channel estimates 20 with respect to each of the one or more UEs 12, each series determined from the access node 16 receiving successive transmissions of an uplink reference signal by a corresponding one of the one or more UEs 12, and each uplink channel estimate dependent upon prevailing uplink propagation paths between the corresponding UE 12 and the access node 16; (b) evaluate the series of uplink channel estimates 20 with respect to the one or more UEs 12, to determine whether changes in the prevailing uplink propagation paths in the series are indicative of a falling object; and (c) output trigger signaling in response to determining that the changes are indicative of a falling object.

FIG. 8 illustrates an arrangement for an access node 16 according to one embodiment, where the access node 16 comprises a central unit (CU) 110 and one or more remote radio units (RRUs) 112. Two RRUs 112-1 and 112-2 are shown in the example depiction, with each RRU 112 including an antenna array 18 for transmitting signals to and receiving signals from respective UEs 12 served by the RRU 112. The CU 110 may be remote from the RRUs 112, and it may implement a processing node 34 for falling object detection operations, or it may output the uplink channel estimates 20 or underlying reception data, for use by a processing node 34 implemented elsewhere in the wireless communication network 30.

FIG. 9 illustrates one implementation of the processing circuitry 60 of a processing node 34, with the understanding that such processing circuitry 60 may be included in or subsumed by the processing circuitry 80 of an access node 16, in embodiments where the access node 16 implements the processing-node functionality. In the example arrangement, the processing circuitry 60 is realized at least in part as one or more microprocessors 120 that are specially adapted based on the execution of stored computer program instructions 124 held in a memory 122 that is included in or coupled to the one or more microprocessors 120. The memory 122 may be part of the earlier mentioned storage 62 or 82, and the computer program instructions 124 may be comprised in the earlier-mentioned computer program 64 or 84.

FIG. 10 illustrates another embodiment of a processing node 34—e.g., an access node 16 or another node in a wireless communication network 30 that is configured to detect free falling objects based on evaluating uplink channel estimates 20 that are affected by the object falling in or through the space intervening between one or more UEs 12 and an access node 16 serving those UEs 12. The processing node 34 according to FIG. 10 comprises one or more processing units or modules, including: an obtaining module 130 that is configured to obtain a series of uplink channel estimates 20 with respect to each of one or more UEs 12, each series determined from the access node 16 receiving successive transmissions of an uplink reference signal 14 by a corresponding one of the one or more UEs 12, and each uplink channel estimate 20 dependent upon prevailing uplink propagation paths between the corresponding UE 12 and the access node 16; an evaluating module 132 that is configured to evaluate the series of uplink channel estimates 20 to determine whether changes in the prevailing uplink propagation paths in the series are indicative of a falling object; and an outputting module 134 that is configured to output trigger signaling in response to determining that the changes are indicative of a falling object.

The modules 130, 132, and 134 may be understood as functional circuits or processing logic. In at least one embodiment, the modules 130, 132, and 134 are instantiated as virtualized processing circuitry. Of course, virtualized processing circuitry is based on underlying physical resources, such as computing resources, memory resources, etc.

Whether implemented via the modules 130, 132, and 134 depicted in FIG. 10, or implemented via another arrangement, a processing node 34 in one or more embodiments supports an overall methodology for falling object detection that includes the following operations:
1. Determine the distance to a reflecting object.
2. Evaluate signal-to-noise ratio or similar measure of the reflection signal, to use only sufficiently strong reflections taps of a multipath signal for further evaluation.
3. For a determined useful signal path:
   a. determine angle (horizontal/vertical) to the object;
   b. from the angle/distance measure, calculate coordinates [xi, yi, zi] for time sequence ti;
   c. based on an applicable set of coordinates, calculate acceleration vector for selected signal reflection; and
   d. based on a calculated deviation between the calculated acceleration vector and the characteristic gravity vector being smaller than quality threshold, determine the involved object is in free fall, and determine event information.
4. Responsive to determining that the involved object is in a free fall, and subject to any qualifying conditions, such as event thresholds, object size minimums, involved location or zone, severity, status of involved area (e.g., in use, closed, vehicles present/not-present, etc.), output trigger signaling.

The trigger signaling may be sent towards a designated node, which may be an Application Function (AF) within or external to the network. In one or more embodiments, the triggering signaling is sent towards a managing server within the RAN 32 or the CN 36 of the wireless communication network 30, which either takes action or forwards the signaling or related signaling towards another node, for action in response to the detection event. In the context of roadways, railways, or other transit ways, the trigger signaling comprises or initiates signaling to generate alerts or initiate controls, to prevent vehicles from entering the zone or region corresponding to the detection event. In such context, the wireless communication network 30 provides communication services, e.g., not only for UEs 12 operating as sensors or other monitoring devices, but also for other types of UEs that may be operating within the coverage area(s) of the wireless communication network 30, and further provides falling object detection. By such arrangements, the need for dedicated or single-purpose detection systems is eliminated, thus saving significant expenses.

In an example case, a typical highway tunnel may have a maximum ceiling height of about six meters, which corresponds to a falling time of about 1.1 seconds, ignoring any air resistance or drag effects. A free fall time of 1.1 seconds corresponds to a series of 200-5000 channel estimates for a contemporary wireless communication system. That is, during the time it takes for a rock, ceiling panel, or other object to fall from a height of six meters, a UE 12 in the wireless communication system 30 may perform hundreds of uplink reference signal transmissions, with the access node 16 serving that UE 12 generating corresponding uplink channel estimates 20, based on its reception of those uplink reference signal transmissions. Such operations provide the basis for the access node 16 or, more generally, any designated processing node 34 in the wireless communication network 30 to evaluate potentially hundreds of uplink channel estimates 20 representing a succession of “samples” that are close together in time in comparison to the speed and acceleration of a free falling object. Indeed, in dependence on the computational power allocated to the evaluation task, a processing node 34 may generate an alarm or otherwise output trigger signaling even before a detected object hits the ground.

Various arrangements are possible, in alignment with or in addition to the arrangements explicitly illustrated in the accompanying figures. For example, a single radio node may perform both the reference signal transmissions and the corresponding receptions of reflected reference signals and may perform the evaluations needed for falling object detection. The node may operate in half-duplex mode, based on rapidly switching between transmit and receive modes, or the node may operate in full-duplex mode, where it transmits and receives simultaneously.

In another approach, one radio node acts as the transmitter of reference signals, while another radio node receives the transmitted reference signals, including any reflections from objects intervening between the transmitting and receiving nodes. Also, a node that acts as a receiver with respect to another node may act as a transmitter with respect to that other node or yet another node.

Further, as noted before, the reference signals transmitted for falling object detection may be “normal” reference signals that are transmitted according to the particulars of the wireless communication network 30. In a slight variation, the reference signals are normal signals of the type used for transmit/receive channel estimation by respective entities within the wireless communication network 30, but they may be transmitted more frequently or according to a different scheduling arrangement, as compared to transmissions used for conventional channel estimation. Still further, the reference signals may be dedicated, e.g., transmitted at special times or transmitted using special code sequences, etc., such that the wireless communication network 30 or UEs 12 communicating therewith transmit one or more types of reference signals for channel estimation purposes, and one or more other types of reference signals for falling object detection. However, there are advantages in reusing as much of the normal operations and signal transmissions of the wireless communication network 30 as possible, for falling object detection, as such reuse avoids extra signaling and computation. Here, “normal” refers to the operations of the wireless communication network 30 that are carried out as part of providing communication services.

In an operating scenario, an access node 16 requests that a UE 12 transmit known reference signals which are normally used for communication-channel estimation. The reference signals are preferably distributed over a certain bandwidth. By analyzing the received reference signals, as received by an antenna array 18 of the access node 16, both the direction and length of propagation paths of a multipath channel are detected, at least for paths of sufficient strength. Here, “direction” should be interpreted as in both dimensions, azimuth, and elevation. Evaluation of the channel estimates 20 includes a number of steps. In an example embodiment, such steps include the below enumerated items.
1. Determine from the received reference signals the distance (di) to a backscattering object Pi.
   Propagation delay (and hence corresponding path distance) between transmission and reception is available by using a known transmitted signal and assuming time synchronization between the UE 12 as the transmitter and the access node 16 as the receiver.
   A multi-antenna receiver, such as the antenna array 18, can detect direction of individual paths by relative phase analysis among receive antennas and the distance calculation can hence be made individually per path.
   Information on distance and direction of a path combined with knowledge of the transmitter position relative to the receiver is enough to establish the position of a single reflection—e.g., information on distance and direction supports determining whether a signal has traveled on a direct path between the transmitter and receiver without any reflections.
   Detection of changes in these reflection positions indicates movement of the reflecting object.
2. Assuming a fixed position for the access node 16 for the time period T, and that at least three different positions of a reflecting object are determined at known time instances, then at least one acceleration vector estimate can be determined by:
   Let K be the number occasions when an objects position has been estimated during the time period T. Let p̅ₖ(k=1 . . . K) be the set of vectors, unit meters [m], defined by the positions detected at times tₖ in seconds [s] e.g. p̅ₖ=[xₖ, yₖ, zₖ] being the vector representing the detected position at time tₖ (p̅ₖ here in rectangular coordinates but the actual coordinate system is not important).
   Define a new set v̅ₘ of M=K−1 vectors by v̅ₘ₊₁−p̅ₘ/t₊₁−tₘ(m=1 . . . M) representing an estimation of velocity vector samples over the time period T.
   In a similar manner define an additional set āₙ of N=M−1 vectors by āₙ=v̅pₙ₊₁−v̅ₙ/(tₙ₊₂−tₙ)/2(n=1 . . . N) representing acceleration vector estimates.
3. Assuming that the “down” direction is known, a comparison can be made between the N calculated acceleration vectors and the gravitational acceleration vector, as follows:
   Create a reference vector g̅ pointing vertically downwards and having the magnitude of the gravitational acceleration (˜9.8 m/s2);
   Construct a resulting set of vectors r̅ₙ=āₙ−g̅. The resulting vector r̅ₙ represents the deviation from the trajectory of a free-falling object for each acceleration estimate; and
   In a basic embodiment, a threshold value e may be defined for deciding if the object was free falling or not, i.e., the object is considered free falling if |r̅ₙ|e, for all n, otherwise not.
      In one embodiment, that the threshold requirement for <e must not consider all samples, but some larger majority e.g., >90%;
      In another embodiment, an improvement may include a threshold value e considering how many (reflection) samples that were used in previous vector calculations.
4. When object is determined as free falling, trigger a tagging of the set of positions as “matching free fall”, where the tagging further associates a selected event with the causing trace position, time, etc.
5. The trigger action may convey information from the detecting node, comprising event information like:
   Absolute or relative position of object determined being subject to free-fall;
   a quality-of-detection estimate;
   a time of event;
   an object-size estimation; and
   a point of impact, e.g., on the ground, roadway, floor, or other surface, with the impact point derived from relative angles and positions, e.g., antenna height, detected positions of object, etc.
6. In a next step, a managing node obtains the event information from the sensing node.
7. The managing node, e.g., a processing node 34, determines:
   “measure <> threshold” (i.e., evaluated whether the measurement is greater than or less than a threshold, and respond accordingly)
   object has fallen at position X
   Execute alarm, etc.
   IF “severity” >threshold
      (e.g., event of falling object size >thr AND “populated area” AND “traffic==yes”)
      issue access blocking for inbound access/traffic to area X
      provide cause message for traffic (i.e., person, vehicle, equipment), here the managing server with <cause message> may be located in RAT sensing node, or any node within the wireless communication network.
8. 2Traffic (person, vehicle) managing server from managing node obtains:
   <cause message> comprising information such as:
      area, cause, time, etc.
   and put <area>indicated by <cause message>into no-enter state
   possible additional operations.

Regarding Item 8 immediately above, a traffic managing server is incorporated in or communicatively coupled to the processing node and is configured to manage, for example, traffic in the affected area, which may be persons walking or vehicles driving, and may obtain a “potential trouble” indication from the processing node of the wireless communication system. For example, the traffic managing server receives a “cause” message comprising information indicating that “some trouble” has been identified in area X, at time T, accompanied with an indicated cause-tag. Based on such information, the traffic managing server may consider notifying, restricting, or blocking human/vehicle traffic into the area, with the particular action(s) taken dependent on the characteristics of the “cause”. For example: if the processing node has detected “one smaller object” determined falling in a less populated region of considered traffic infrastructure, then the traffic managing server may issue a security notification for concerned parties to take precaution for any next visit (that may be scheduled days ahead in time); if the processing node detected “one or more larger falling object in a frequently populated area of the traffic infrastructure (e.g., at a traffic intersection of two main roads or another critical event)”, then the traffic managing server may put inbound roads towards said intersection into blocked state and prohibit visits to that zone; and if the processing node has detected a critical event, i.e., an event of maximum severity, the traffic managing server may initiate not only traffic blocking but may also trigger evacuation operations or other emergency actions.

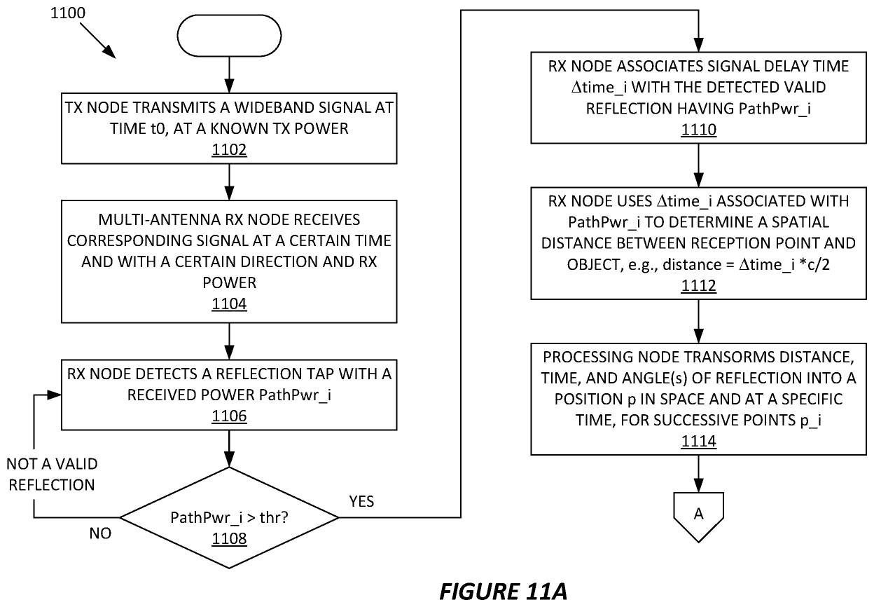

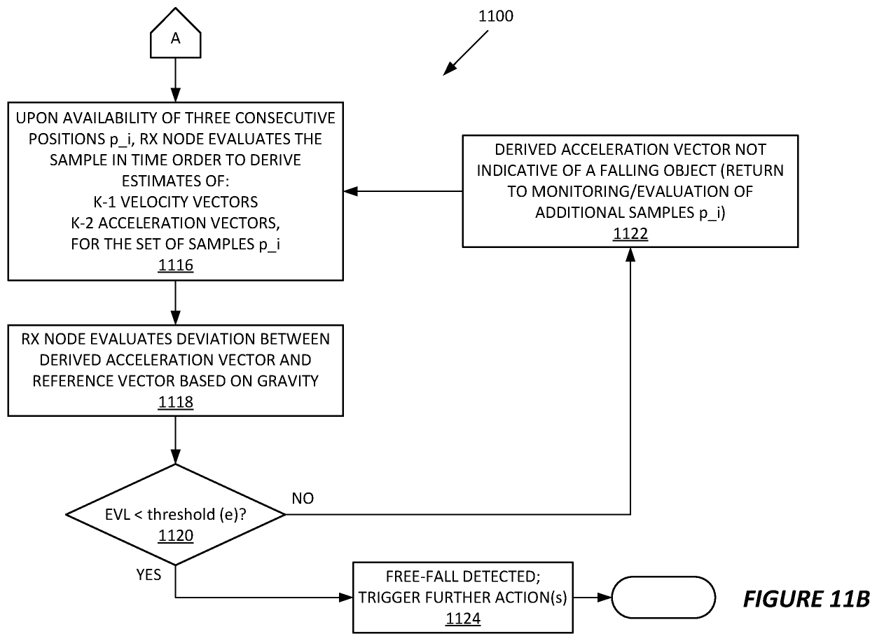

FIGS. 11A and 11B depict a method 1100 of operation according to one or more embodiments. According to the diagram, the method 1100 includes a transmit (TX) node transmitting (Block 1102) a wideband signal at time t0, at a known TX power. Examples include an access node 16 transmitting the signal in question, for reception by a UE 12 or even another access node 16. In another example, the TX node is a UE 12, and the wideband signal is an uplink reference signal.

Operations continue with a multi-antenna receiver (RX) node receiving (Block 1104) the transmitted signal at a corresponding time, and with a certain direction and RX power. With respect to the received signal, the RX node detects (Block 1106) a reflection tap with a received power, denoted as PathPwr_i and evaluates (Block 1108) the received signal power or other measure against a defined threshold thr, to determine whether the reflection qualifies as a detected valid reflection. If not, processing returns to Block 1106, for evaluation of remaining taps. If so, processing continues with the RX node associating (Block 1110) a signal delay time Δtime i with the detected valid reflection having PathPwr_i. The RX node then uses (Block 1112) to determine the spatial distance Di between the reception point and the object. The RX node then transforms (Block 1114) the distance, time, and angular information into a position p in space, at time i, i.e., position p_i.

With at least three such consecutive positions p_i determined (number K of positions is three or greater), the RX node calculates (Block 1116) K-1 velocity vectors v̅ₘ, K−2acceleration vectors aₙ, for the set K of p_i positions, which are coordinate-time samples. Processing continues with the RX node evaluating (Block 1118) the deviation between the above derived acceleration vector and a reference vector based on gravity. For example, a deviation vector rₙ=āₙ−g, where g is the acceleration vector corresponding to gravity and points vertically downward. The vectors r̅ₙ thus reflects the set of N=K−2 error vectors representing deviations between the computed acceleration of the involved reflecting object and the acceleration of gravity.

The RX node then performs a comparison (Block 1120) of an error value EVL against an error threshold, denoted as threshold (e). “EVL” denotes an error vector length, which the RX node computes as a length value—a scalar, e.g., the L2-norm of the error vector In. For example, EVL=|r̅ₙ|. The RX node deems the condition of EVL being less than the threshold error as detection of a free falling object (YES from Block 1120), and processing continues with triggering (Block 1124) further actions, e.g., outputting trigger signaling. “NO” from Block 1120 flows into Block 1122, where the RX node determines that it has not detected a free falling object and it returns to monitoring, including further evaluation of additional p_i samples. For example, with respect to a running set of samples, the path detection and evaluation process may be run repeatedly according to a moving window.

Although discussion of the method 1100 refers to the RX node performing the signal evaluations and falling-object detection operations, it shall be understood that in general a processing node 34 performs such operations. For example, the RX node is an access node 16 and it operates as the processing node 34, or the access node 16 outputs the underlying reference-signal data, e.g., uplink channel estimates 20, that are used by another node acting as the processing node 34.

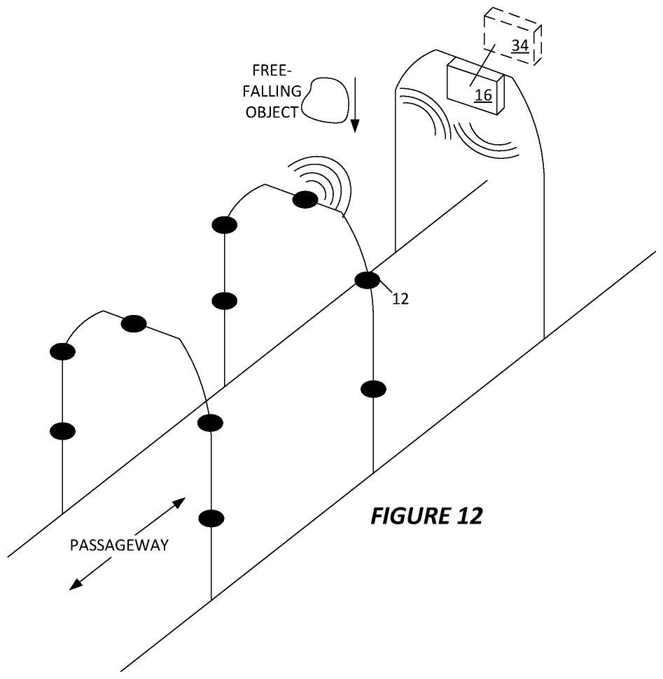

FIG. 12 illustrates an example deployment in a tunnel or mine, wherein UEs 12 are embedded or otherwise attached to the interior of the tunnel or mine, e.g., the UEs 12 are integrated with or attached using rock bolts. An access node 16, or multiple access nodes 16 are positioned so as to have wireless connectivity to the UEs 12.

The UEs 12 transmit uplink reference signals 14 and the access node 16 receives them, e.g., using an antenna array 18, which is not shown in the diagram. The access node 16 is associated with, or is configured to operate as, a processing node 34 that evaluates uplink channel estimates 20 that are derived from reception by the access node 16 of the uplink reference signals 14, for detection of rocks or other free falling objects within the mine or tunnel. Among advantages such as speed of detection and ability to communicate with essentially any type of external system, the arrangement of FIG. 12 offers the advantage of providing communications-signal coverage along the length of the mine or tunnel, while using that same equipment to provide falling object detection within the mine or tunnel.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method (700) of operation by a processing node (34) of a wireless communication system (30), wherein the processing node (34) is integrated or associated with an access node (16) of the wireless communication network (30), the method (700) comprising:
obtaining (704) a series of uplink channel estimates (20) with respect to each of one or more user equipments (UEs) (12), each series determined from the access node (16) receiving successive transmissions of an uplink reference signal (14) by a corresponding one of the one or more UEs (12), and each uplink channel estimate (20) dependent upon prevailing uplink propagation paths between the corresponding UE (12) and the access node (16);
evaluating (706) the series of uplink channel estimates (20) to determine whether changes in the prevailing uplink propagation paths in the series are indicative of a falling object; and
outputting (708) trigger signaling in response to determining that the changes are indicative of a falling object.

2. The method (700) according to claim 1, wherein the one or more UEs (12) comprise two or more UEs (12) and wherein (706) evaluating the series of uplink channel estimates (20) to determine whether changes in the prevailing uplink propagation paths in the series are indicative of a falling object comprises independently evaluating the series from each UE (12) and outputting (708) the trigger signaling responsive to the changes in any one or more of the series being indicative of a falling object.

3. The method (700) according to claim 1, wherein the one or more UEs (12) comprise two or more UEs (12) and wherein evaluating (706) the series of uplink channel estimates (20) to determine whether changes in the prevailing uplink propagation paths in the series are indicative of a falling object comprises jointly evaluating the series from at least two of the two or more UEs (12) and outputting (708) the trigger signaling responsive to the changes in the jointly-evaluated series being indicative of a falling object.

4. The method (700) according to any one of claims 1-3, wherein each channel estimate (20) comprises path delay and direction estimates, such that the changes in each series of channel estimates (20) comprise changes in the path delays and direction estimates over successive ones of the channel estimates (20) comprised in the series.

5. The method (700) according to claim 4, wherein evaluating (706) the series of uplink channel estimates (20) to determine whether changes in the prevailing uplink propagation paths in the series are indicative of a falling object comprises determining whether any one or more of the series exhibit path changes characteristic of objects free falling under the force of gravity.

6. The method (700) according to any one of claims 1-5, wherein the one or more UEs (12) are respective sensor devices, wherein the processing node (34) is the access node (16), and wherein the method (700) further comprises the access node (16) receiving uplink data from each of the one or more UEs (12), via respective uplink data transmissions, for sending towards an external host computer (42).

7. The method (700) according to claim 6, the method (700) further comprising the access node (16) using the series of uplink channel estimates (20) corresponding to each UE (12), or further channel estimates based on the underlying reference-signal reception data from which the series of uplink channel estimates (20) are derived, for receiving the uplink data from the UE (12).

8. The method (700) according to any one of claims 1-7, wherein each UE (12) among the one or more UEs (12) has a known location relative to reception equipment included in or used by the access node (16) for reception of the uplink reference signal transmissions, and wherein evaluating (706) the series of uplink channel estimates (20) to determine whether changes in the prevailing uplink propagation paths in the series are indicative of a falling object is based on using the known locations of the UEs (12) to identify propagation-path changes that correlate with an object free falling under the force of gravity.

9. A system comprising:
one or more User Equipments (UEs) (12) positioned in an area to be monitored for falling objects, each UE (12) comprising a sensor device that communicates sensor data via uplink data transmissions;
an access node (16) comprising or associated with reception equipment configured to receive the uplink data transmissions from each of the one or more UEs (12), along with uplink reference signals (14) transmitted from each of the one or more UEs (12); and
a processing node (34) that is integrated or associated with the access node (16), the processing node (34) configured to:
obtain a series of uplink channel estimates (20) with respect to each of the one or more UEs (12), each series determined from the access node (16) receiving successive transmissions of an uplink reference signal (14) by a corresponding one of the one or more UEs (12), and each uplink channel estimate dependent upon prevailing uplink propagation paths between the corresponding UE (12) and the access node (16);
evaluate the series of uplink channel estimates (20) with respect to the one or more UEs (12), to determine whether changes in the prevailing uplink propagation paths in the series are indicative of a falling object; and
output trigger signaling in response to determining that the changes are indicative of a falling object.

10. A processing node (34) integrated or associated with an access node (16) of a wireless communication system (30), the processing node (34) comprising:
communication interface circuitry (50); and
processing circuitry (60) configured to:
obtain a series of uplink channel estimates (20) with respect to each of one or more user equipments (UEs) (12), each series determined from the access node (16) receiving successive transmissions of an uplink reference signal (14) by a corresponding one of the one or more UEs (12), and each uplink channel estimate (20) dependent upon prevailing uplink propagation paths between the corresponding UE (12) and the access node (16);
evaluate the series of uplink channel estimates (20) to determine whether changes in the prevailing uplink propagation paths in the series are indicative of a falling object; and
output, via the communication interface circuitry (50), trigger signaling in response to determining that the changes are indicative of a falling object.

11. The processing node (34) according to claim 10, wherein the one or more UEs (12) comprise two or more UEs (12) and wherein the processing circuitry (60) is configured to evaluate the series of uplink channel estimates (20) to determine whether changes in the prevailing uplink propagation paths in the series are indicative of a falling object by independently evaluating the series from each UE (12) and outputting the trigger signaling responsive to the changes in any one or more of the series being indicative of a falling object.

12. The processing node (34) according to claim 10, wherein the one or more UEs (12) comprise two or more UEs (12) and wherein the processing circuitry (60) is configured to evaluate the series of uplink channel estimates (20) to determine whether changes in the prevailing uplink propagation paths in the series are indicative of a falling object by jointly evaluating the series from at least two of the two or more UEs (12) and outputting the trigger signaling responsive to the changes in the jointly-evaluated series being indicative of a falling object.

13. The processing node (34) according to any one of claims 10-12, wherein each channel estimate (20) comprises path delay and direction estimates, such that the changes in each series of channel estimates (20) comprise changes in the path delays and direction estimates over successive ones of the channel estimates (20) comprised in the series.

14. The processing node (34) according to claim 13, wherein the processing circuitry (60) is configured to evaluate the series of uplink channel estimates (20) to determine whether changes in the prevailing uplink propagation paths in the series are indicative of a falling object by determining whether any one or more of the series exhibit path changes characteristic of objects free falling under the force of gravity.

15. The processing node (34) according to any one of claims 10-14, wherein the one or more UEs (12) are respective sensor devices, wherein the processing node (34) is the access node (16), and wherein the access node (16) is configured to receive uplink data from each of the one or more UEs (12), via respective uplink data transmissions, for sending towards an external host computer (42).

16. The processing node (34) according to claim 15, wherein the access node (16) is configured to use the series of uplink channel estimates (20) corresponding to each UE (12), or further channel estimates based on the underlying reference-signal reception data from which the series of uplink channel estimates (20) are derived, for receiving the uplink data from the UE (12).

17. The processing node (34) according to any one of claims 10-16, wherein each UE (12) among the one or more UEs (12) has a known location relative to reception equipment included in or used by the access node (16) for reception of the uplink reference signal transmissions, and wherein the processing circuitry (60) is configured to evaluate the series of uplink channel estimates (20) to determine whether changes in the prevailing uplink propagation paths in the series are indicative of a falling object, based on using the known locations of the UEs (12) to identify propagation-path changes that correlate with an object free falling under the force of gravity.

1-17. (canceled)

18. A method of operation by a processing node of a wireless communication system, wherein the processing node is integrated or associated with an access node of the wireless communication network, the method comprising:
obtaining a series of uplink channel estimates with respect to each of one or more user equipments (UEs), each series determined from the access node receiving successive transmissions of an uplink reference signal by a corresponding one of the one or more UEs, and each uplink channel estimate dependent upon prevailing uplink propagation paths between the corresponding UE and the access node;
evaluating the series of uplink channel estimates to determine whether changes in the prevailing uplink propagation paths in the series are indicative of a falling object; and
outputting trigger signaling in response to determining that the changes are indicative of a falling object.

19. The method according to claim 18, wherein the one or more UEs comprise two or more UEs and wherein evaluating the series of uplink channel estimates to determine whether changes in the prevailing uplink propagation paths in the series are indicative of a falling object comprises independently evaluating the series from each UE and outputting the trigger signaling responsive to the changes in any one or more of the series being indicative of a falling object.

20. The method according to claim 18, wherein the one or more UEs comprise two or more UEs and wherein evaluating the series of uplink channel estimates to determine whether changes in the prevailing uplink propagation paths in the series are indicative of a falling object comprises jointly evaluating the series from at least two of the two or more UEs and outputting the trigger signaling responsive to the changes in the jointly-evaluated series being indicative of a falling object.

21. The method according to claim 18, wherein each channel estimate comprises path delay and direction estimates, such that the changes in each series of channel estimates comprise changes in the path delays and direction estimates over successive ones of the channel estimates comprised in the series.

22. The method according to claim 21, wherein evaluating the series of uplink channel estimates to determine whether changes in the prevailing uplink propagation paths in the series are indicative of a falling object comprises determining whether any one or more of the series exhibit path changes characteristic of objects free falling under the force of gravity.

23. The method according to claim 18, wherein the one or more UEs are respective sensor devices, wherein the processing node is the access node, and wherein the method further comprises the access node receiving uplink data from each of the one or more UEs, via respective uplink data transmissions, for sending towards an external host computer.

24. The method according to claim 23, the method further comprising the access node using the series of uplink channel estimates corresponding to each UE, or further channel estimates based on the underlying reference-signal reception data from which the series of uplink channel estimates are derived, for receiving the uplink data from the UE.

25. The method according to claim 18, wherein each UE among the one or more UEs has a known location relative to reception equipment included in or used by the access node for reception of the uplink reference signal transmissions, and wherein evaluating the series of uplink channel estimates to determine whether changes in the prevailing uplink propagation paths in the series are indicative of a falling object is based on using the known locations of the UEs to identify propagation-path changes that correlate with an object free falling under the force of gravity.

26. A system comprising:
one or more User Equipments (UEs) positioned in an area to be monitored for falling objects, each UE comprising a sensor device that communicates sensor data via uplink data transmissions;
an access node comprising or associated with reception equipment configured to receive the uplink data transmissions from each of the one or more UEs, along with uplink reference signals transmitted from each of the one or more UEs; and
a processing node that is integrated or associated with the access node, the processing node configured to:
obtain a series of uplink channel estimates with respect to each of the one or more UEs, each series determined from the access node receiving successive transmissions of an uplink reference signal by a corresponding one of the one or more UEs, and each uplink channel estimate dependent upon prevailing uplink propagation paths between the corresponding UE and the access node;
evaluate the series of uplink channel estimates with respect to the one or more UEs, to determine whether changes in the prevailing uplink propagation paths in the series are indicative of a falling object; and
output trigger signaling in response to determining that the changes are indicative of a falling object.

27. A processing node integrated or associated with an access node of a wireless communication system, the processing node comprising:
communication interface circuitry; and
processing circuitry configured to:
obtain a series of uplink channel estimates with respect to each of one or more user equipments (UEs), each series determined from the access node receiving successive transmissions of an uplink reference signal by a corresponding one of the one or more UEs, and each uplink channel estimate dependent upon prevailing uplink propagation paths between the corresponding UE and the access node;
evaluate the series of uplink channel estimates to determine whether changes in the prevailing uplink propagation paths in the series are indicative of a falling object; and
output, via the communication interface circuitry, trigger signaling in response to determining that the changes are indicative of a falling object.

28. The processing node according to claim 27, wherein the one or more UEs comprise two or more UEs and wherein the processing circuitry is configured to evaluate the series of uplink channel estimates to determine whether changes in the prevailing uplink propagation paths in the series are indicative of a falling object by independently evaluating the series from each UE and outputting the trigger signaling responsive to the changes in any one or more of the series being indicative of a falling object.

29. The processing node according to claim 27, wherein the one or more UEs comprise two or more UEs and wherein the processing circuitry is configured to evaluate the series of uplink channel estimates to determine whether changes in the prevailing uplink propagation paths in the series are indicative of a falling object by jointly evaluating the series from at least two of the two or more UEs and outputting the trigger signaling responsive to the changes in the jointly-evaluated series being indicative of a falling object.

30. The processing node according to claim 27, wherein each channel estimate comprises path delay and direction estimates, such that the changes in each series of channel estimates comprise changes in the path delays and direction estimates over successive ones of the channel estimates comprised in the series.

31. The processing node according to claim 30, wherein the processing circuitry is configured to evaluate the series of uplink channel estimates to determine whether changes in the prevailing uplink propagation paths in the series are indicative of a falling object by determining whether any one or more of the series exhibit path changes characteristic of objects free falling under the force of gravity.

32. The processing node according to claim 27, wherein the one or more UEs are respective sensor devices, wherein the processing node is the access node, and wherein the access node is configured to receive uplink data from each of the one or more UEs, via respective uplink data transmissions, for sending towards an external host computer.

33. The processing node according to claim 32, wherein the access node is configured to use the series of uplink channel estimates corresponding to each UE, or further channel estimates based on the underlying reference-signal reception data from which the series of uplink channel estimates are derived, for receiving the uplink data from the UE.

34. The processing node according to claim 27, wherein each UE among the one or more UEs has a known location relative to reception equipment included in or used by the access node for reception of the uplink reference signal transmissions, and wherein the processing circuitry is configured to evaluate the series of uplink channel estimates to determine whether changes in the prevailing uplink propagation paths in the series are indicative of a falling object, based on using the known locations of the UEs to identify propagation-path changes that correlate with an object free falling under the force of gravity.
